(19) United States
(12) Patent Application Publication
(10) Pub. No.: US 2005/0277341 A1
(43) Pub. Date: Dec. 15, 2005

(54) Terminal press-fitting structure

(76) Inventor: Yukio Noguchi, Kanagawa (JP)

Correspondence Address: BARLEY SNYDER, LLC, 1000 WESTLAKES DRIVE, SUITE 275, BERWYN, PA, 19312, US

(21) Appl. No.: 11/148,492

(22) Filed: Jun. 9, 2005

(30) Foreign Application Priority Data
Jun. 9, 2004 (JP) 2004-171393

(51) Int. Cl. H01R 13/40

(52) U.S. Cl. 439/884

(57) ABSTRACT

It is an object of the present invention to provide a terminal press-fitting structure in which the retention strength of the terminal can be increased without increasing the unfolded length of the terminal. In this terminal press-fitting structure, the press-fitting part is press-fitted into the housing as a result of the plurality of barbs that are formed to protrude from each of the two side edges of the press-fitting part main body of the terminal biting into the inner walls of the press-fitted hole in the housing that receives the press-fitting part of the terminal. The press-fitting part is constructed as a single-layer flat plate structure, the plurality of barbs are constructed so that the tip ends of these barbs are alternately positioned toward one side and the other side of the opposing main surfaces of the press-fitting part.

### FIELD OF THE INVENTION

The present invention relates to a terminal press-fitting structure in which the press-fitting part of a terminal is press-fitted into a housing.

### BACKGROUND

Types of terminals generally include a male type terminal such as a tab terminal or a post terminal, and a female type terminal such as a receptacle terminal that accommodates a male terminal.

Among these terminals, the terminal shown in FIGS. 5A through 5C (see JP49-65984U), for example, has been conventionally known as a tab terminal.

This tab terminal 101 is formed as a double-layer structure by folding a single metal plate. A plurality of barbs (saw blade-form projections) 104 are formed on the respective two side edges of one metal piece 102 and the other metal piece 103, and a press-fitting part 105 is constructed so that the barbs 104 on the first metal piece 102 and the barbs 104 on the second metal piece 103 are shifted in the direction of plate thickness with respect to each other. Furthermore, the press-fitting part 105 of this tab terminal 101 is designed to be press-fitted into a hole 111 in a housing (synthetic resin molded stand) 110. The press-fitting of the press-fitting part 105 into the hole 111 is accomplished by the barbs 104 biting into the inner walls of the hole 111.

In this tab terminal 101, since the barbs 104 on the first metal piece 102 and the barbs 104 on the second metal piece 103 are shifted in the direction of plate thickness with respect to each other, when the barbs 104 are caused to bite into the inner walls of the hole 111, the portions of the inner walls that are bit into by the barbs 104 on the first metal piece 102 and the portions of the inner walls that are bit into by the barbs 104 on the second metal piece 103 differ in the direction of plate thickness. Therefore, it is possible to obtain a tab terminal 101 that has a high retention strength with respect to the housing 110.

However, the following problems have been encountered in this conventional tab terminal 101:

Specifically, the tab terminal 101 is formed as a double-layer structure by folding a single metal plate, and the press-fitting part 105 is also formed as a double-layer structure. Accordingly, the unfolded length is great, resulting in a problem of high manufacturing cost.

Furthermore, since the barbs 104 of the tab terminal 101 bite into the rectilinear inner walls of the hole 111 in the housing 110, the retention strength of the tab terminal 101 is dependent solely upon the engaging margins of the barbs 104 with the inner walls, so that it is difficult to increase the retention strength.

### SUMMARY

Accordingly, the present invention was devised in light of the problems described above; it is an object of the present invention to provide a terminal press-fitting structure in which the retention strength of the terminal can be increased without increasing the unfolded length of the terminal.

In order to solve the problems described above, a terminal press-fitting structure is provided in which a plurality of barbs that are formed to protrude from each of the two side edges of the main body of the press-fitting part of a terminal bite into the inner walls of a press-fitted hole in a housing receiving this press-fitting part of the terminal, so that this press-fitting part is press-fitted to the housing, wherein this press-fitting part is constructed as a single-layer flat plate structure, and the plurality of barbs are constructed so that the tip ends of these barbs are alternately positioned toward one side and the other side of the opposing main surfaces of the press-fitting part.

Since the press-fitting part is constructed as a single-layer flat plate structure, there is no increase in the unfolded length of the terminal, compared to a case in which the press-fitting part is constructed as a double-layer structure as in the past. Furthermore, since the plurality of barbs are constructed so that the tip ends of these barbs are alternately positioned toward one side and the other side of the opposing main surfaces of the press-fitting part, when the barbs are caused to bite into the inner walls of the press-fitted hole, the portions of the inner walls that are bit into by the barbs whose tip ends are positioned toward one side of the opposing main surfaces of the press-fitting part, and the portions of the inner walls that are bit into by the barbs whose tip ends are positioned toward the other side of the opposing main surfaces, are different in the direction of plate thickness of the press-fitting part. Accordingly, it is possible to obtain a terminal press-fitting structure that has a high retention strength with respect to the housing.

### BRIEF DESCRIPTION OF THE DRAWINGS

FIG. 1 is a perspective view of a male type terminal that is applied to a terminal press-fitting structure according to an exemplary embodiment of the present invention;

FIGS. 2A and 2B show the male type terminal of FIG. 1, with FIG. 2A being a partial plan view, and FIG. 2B being a sectional view along line 2B-2B in FIG. 2A;

FIGS. 3A through 3D show a terminal press-fitting structure according to an exemplary embodiment of the present invention, with FIG. 3A being a partial horizontal sectional view, FIG. 3B being a sectional view along line 3B-3B in FIG. 3A, FIG. 3C being a sectional view along line 3C-3C in FIG. 3A, and FIG. 3D being an enlarged view of arrow portion A in FIG. 3A;

FIG. 4 is a perspective view showing a state in which a connector to which the terminal press-fitting structure of the present invention is applied is mounted on a circuit board; and

FIGS. 5A through 5C show conventional examples of a tab terminal, with FIG. 5A being a perspective view, FIG. 5B being a vertical sectional view showing a state in which the tab terminal is press-fitted to the housing, and FIG. 5C being a horizontal sectional view showing a state in which the tab terminal is press-fitted to the housing.

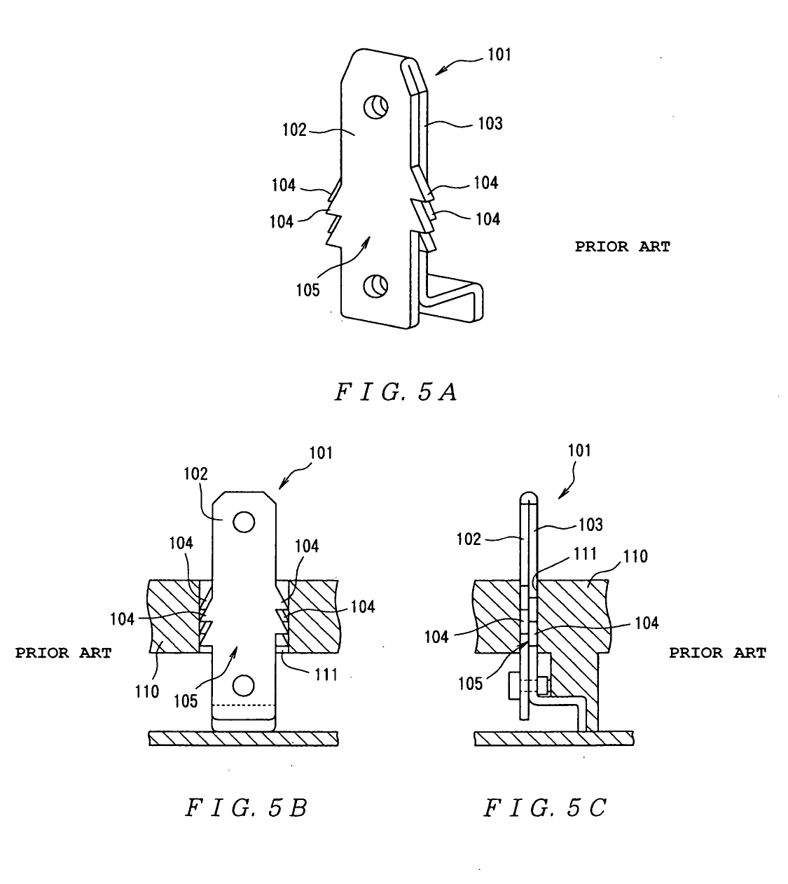

### DETAILED DESCRIPTION OF THE EMBODIMENT(S)

Next, an embodiment of the present invention will be described with reference to the figures.

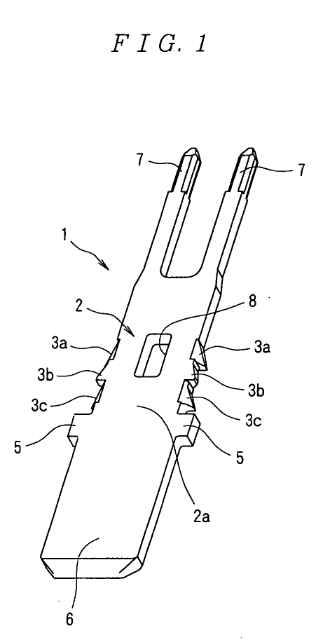

In FIGS. 1, 2A and 2B, and 3A through 3D, the male type terminal 1 comprises a press-fitting part 2 that is received in a press-fitted hole 11 in a housing 10, a pair of leg parts 7 that extend forward from the front end (upper end in FIG. 1) of the press-fitting part 2, and a tab type contact part 6 that extends rearward from the rear end of the press-fitting part 2. The press-fitting part 2 is designed to be inserted into a press-fitted hole 11 in the housing 10 from the rear of the housing toward the front, with the leg parts 7 inserted first.

The press-fitting part 2 is constructed as a single-layer flat plate structure, and a plurality of barbs 3a, 3b and 3c (three barbs on each side edge in the present embodiment) are formed to protrude from each of the two side edges of the main body 2a of this press-fitting part 2 in the direction of width. These barbs 3a, 3b and 3c bite into the inner walls of the press-fitted hole 11 in the housing 10 when the press-fitting part 2 is inserted into the press-fitted hole 11, so that the press-fitting part 2 is press-fitted to the housing 10. The barbs 3a, 3b and 3c are arranged at a specified pitch in the forward-rearward direction of the press-fitting part 2. The respective barbs 3a, 3b and 3c on one side and the respective barbs 3a, 3b and 3c on the opposite side are arranged in the same locations in the forward-rearward direction.

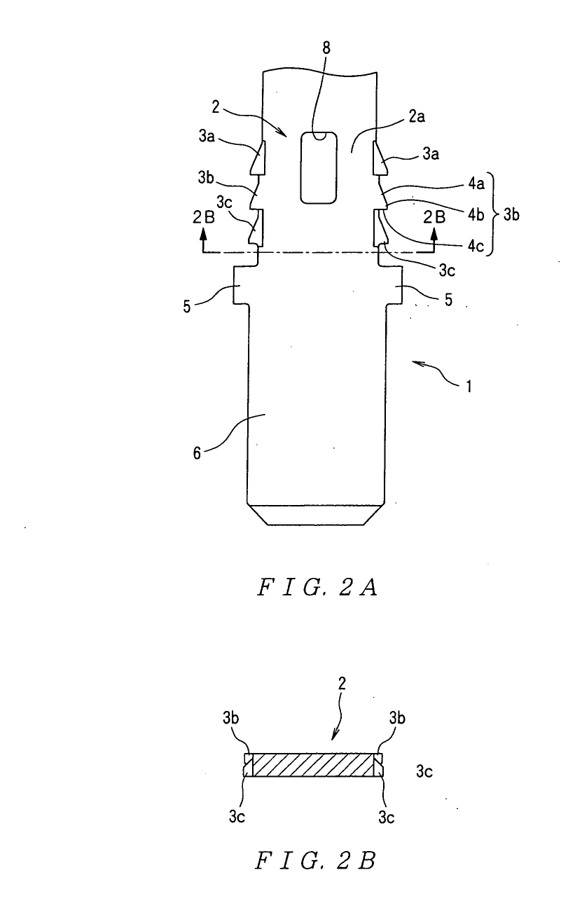

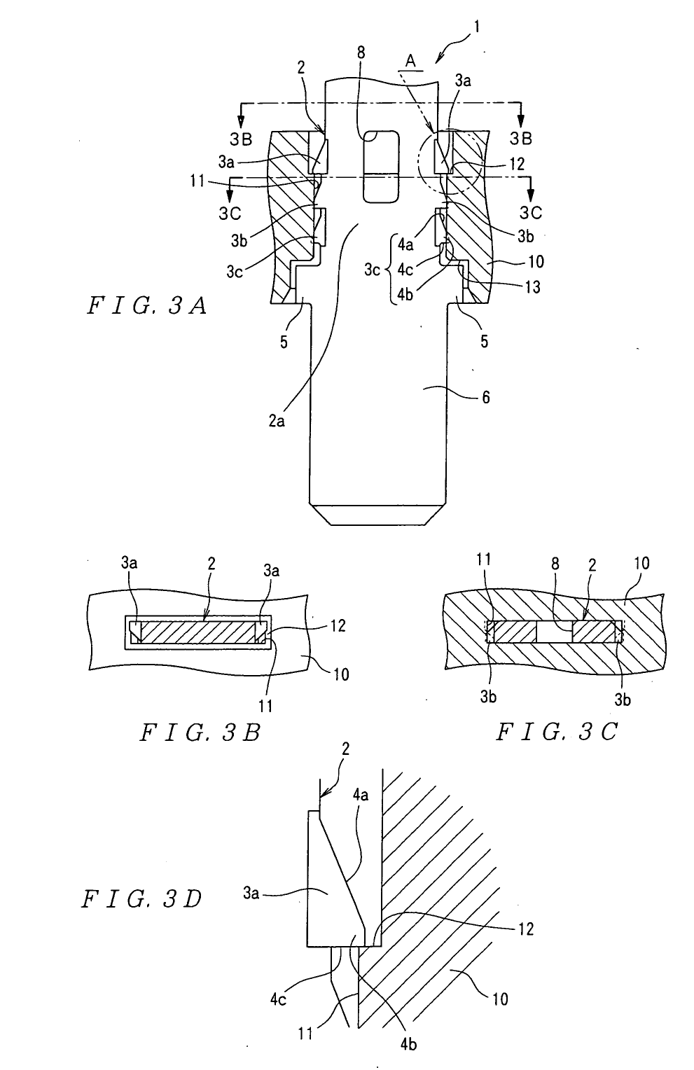

Furthermore, the barbs 3a, 3b and 3c are constructed so that the tip ends of these barbs are alternately positioned toward one side and the other side of the opposing main surfaces of the press-fitting part 2. Specifically, as is shown clearly in FIG. 3B, the tip ends of the barbs 3a located closest to the front are positioned on the side of the back surface (upper surface in FIG. 3B) of the press-fitting part 2. Moreover, as is shown clearly in FIG. 3C, the tip ends of the barbs 3b located in the middle in the forward-rearward direction are positioned on the side of the front surface of the press-fitting part 2. Furthermore, as is shown clearly in FIG. 2B, the tip ends of the barbs 3c located closest to the rear are positioned on the side of the back surface of the press-fitting part 2. The male type terminal 1 is formed by stamping a metal plate and swaging these barbs 3a, 3b and 3c so that the tip ends of these barbs are alternately positioned toward one side and the other side of the opposing main surfaces of the press-fitting part 2.

Moreover, each of the barbs 3a, 3b and 3c comprises an introduction edge 4a that extends from the side edge of the main body 2a of the press-fitting part 2 for the introduction into the press-fitted hole 11, a biting part 4b that is located at the tip end in continuity with the introduction edge 4a and that bites into the inner wall of the press-fitted hole 11, and a locking edge 4c that extends from the biting part 4b toward the press-fitting part main body 2a. The introduction edges 4a constitute inclined edges extending from the respective side edges of the press-fitting part main body 2a at inclination toward rear, and facilitate the insertion of the respective barbs 3a, 3b and 3c into the press-fitted hole 11 when the press-fitting part 2 is inserted into the press-fitted hole 11. Furthermore, each biting part 4b has a front edge that extends continuously “as is” from the inclination of the introduction edge 4a, and a tip end surface that is substantially parallel to the side edge surface of the press-fitting part main body 2a. Moreover, each locking edge 4c is constructed by extending from the rear edge of the tip end surface of the biting part 4b toward the side edge surface of the press-fitting part main body 2a perpendicular to this side edge surface.

A relief hole 8 that allows elastic deformation of the press-fitting part 2 when the barbs 3a, 3b and 3c bite into the inner walls of the press-fitted hole 11 in the housing 10 is formed substantially in the central portion of the press-fitting part 2 in the direction of width.

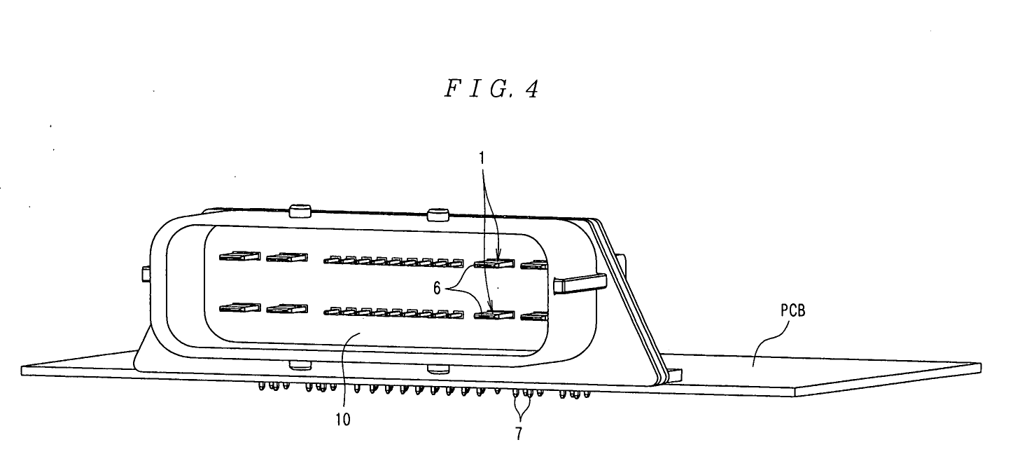

Furthermore, as is shown in FIG. 4, after the press-fitting part 2 is press-fitted to the housing 10, the leg parts 7 are bent at right angles so that these leg parts are connected by 20 soldering to a circuit board PCB.

Moreover, the tab type contact part 6 is constructed from a flat plate having a width slightly greater than that of the press-fitting part main body 2a, and is designed to contact a mating contact (not shown in the figures). Furthermore, a pair of pressing shoulders 5 that are utilized when a jig is used to insert the press-fitting part 2 into the press-fitted hole 11 are formed to protrude from either side edge (in the direction of width) of the front end portion of the tab type contact part 6.

Locking shoulders 12 that are locked by the locking edges 4c of the foremost barbs 3a are formed toward the front of the inner walls of the press-fitted hole 11 in the housing 10. Moreover, recessed parts 13 in which the pressing shoulders 5 are positioned when the press-fitting part 2 is press-fitted to the housing 10 are formed toward the rear of the inner walls of the press-fitted hole 11 in the housing 10.

The male type terminal 1 is formed by stamping a metal plate and swaging these barbs 3a, 3b and 3c so that the tip ends of these barbs are alternately positioned toward one side and the other side of the opposing main surfaces of the press-fitting part 2. Furthermore, the external shapes of the barbs 3a, 3b and 3c may also be formed by performing the stamping following the swaging.

When the press-fitting part 2 is inserted, with the leg parts 7 inserted first, into the press-fitted hole 11 in the housing 10 from the rear of the housing toward the front by pressing the pressing shoulders 5 by means of a jig, the foremost barbs 3a pass into the press-fitted hole 11 while slightly scraping the inner walls of the press-fitted hole 11; as is shown in FIG. 3D, these barbs 3a are caused to lock with the locking shoulders 12 as a result of the locking edges 4c of the barbs 3a being positioned in front of the locking shoulders 12. In this case, the middle barbs 3b between the front and rear move while scraping the inner walls of the press-fitted hole 11, and bite into these inner walls; furthermore, the rearmost barbs 3c also move while scraping the inner walls of the press-fitted hole 11, and bite into these inner walls. As a result, the press-fitting part 2 is press-fitted to the housing 10. The male type terminals 1 and the housing 10 constitute a connector.

Here, the middle barbs 3b between the front barbs 3a and the rearmost barbs 3c are constructed so that the tip ends of these barbs are respectively positioned toward one side (toward the front surface) and toward the other side (toward the back surface) of the opposing main surfaces of the press-fitting part. Accordingly, when the barbs 3b and 3c are caused to bite into the inner walls of the press-fitted hole 11, the portions of the inner walls that are bit into by the barbs 3b whose tip ends are positioned toward the first side (toward the front surface) of the opposing main surfaces of the press-fitting part 2, and the portions of the inner walls that are bit into by the barbs 3c whose tip ends are positioned toward the second side (toward the back surface) of the opposing main surfaces, are different in the direction of plate thickness of the press-fitting part 2, so that it is possible to obtain a terminal press-fitting structure that has a high retention strength with respect to the housing 10. Furthermore, the foremost barbs 3a and the middle barbs 3b (between front and rear) are also constructed so that the tip ends of these barbs are respectively positioned toward the second side (toward the back surface) and toward the first side (toward the front surface) of the opposing main surfaces of the press-fitting part. Accordingly, the portions of the inner walls that are passed through by the barbs 3a whose tip ends are positioned toward the second side (toward the back surface) of the opposing main surfaces of the press-fitting part 2, and the portions of the inner walls that are bit into by the barbs 3b whose tip ends are positioned toward the first side (toward the front surface) of the opposing main surfaces, are different in the direction of plate thickness of the press-fitting part 2, so that it is possible to obtain a terminal press-fitting structure that has a high retention strength with respect to the housing 10.

Moreover, when the press-fitting part 2 is press-fitted to the housing 10, the locking edges 4c of the barbs 3a are positioned in front of the locking shoulders 12 and locked with these locking shoulders 12. Accordingly, the retention strength of the male type terminal 1 is dependent upon the engaging margins of the respective biting parts 4b, 4b of the barbs 3b and 3c with the inner walls of the press-fitted hole 11, as well as the locking force by means of the locking edges 4c of the barbs 3a and the locking shoulders 12, thus making it possible to obtain a terminal press-fitting structure that has a high retention strength with respect to the housing 10.

Furthermore, since the press-fitting part 2 is constructed as a single-layer flat plate structure, there is no increase in the unfolded length of the male type terminal 1, compared to the case in which the press-fitting part is constructed as a double-layer structure as in the past.

An embodiment of the present invention was described above. However, the present invention is not limited to this embodiment, and various alterations or modifications can be made.

For example, there is no need to dispose the respective barbs 3a, 3b and 3c on one side and the respective barbs 3a, 3b and 3c on the opposite side in the same locations in the forward-rearward direction; the positions may also be shifted in the forward-rearward direction.

Furthermore, it is sufficient as long as the barbs 3a, 3b and 3c are constructed so that the tip ends of these barbs are alternately positioned toward one side and the other side of the opposing main surfaces of the press-fitting part 2; it would also be possible to position the tip ends of the foremost barbs 3a toward the front surface of the press-fitting part 2, the tip ends of the middle barbs 3b between the front and rear toward the back surface, and the tip ends of the rearmost barbs 3c toward the front of the press-fitting part 2.

Moreover, it is sufficient as long as the barbs 3a, 3b and 3c are constructed so that the tip ends of these barbs are alternately positioned toward one side and the other side of the opposing main surfaces of the press-fitting part 2; the present invention is not limited to a case in which the barbs are formed by swaging.

In addition, as long as the number of the barbs is plural, the number is not limited to three.

Furthermore, the terminal having a press-fitting part is not limited to a male type terminal, and may also be a female type terminal having a spring contact part.

1. A terminal press-fitting structure comprising:
a main body having two side edges;
a press fitting part located on the main body and constructed as a single-layer flat plate structure having opposing main surfaces; and
a plurality of barbs protruding from each of the two side edges at the press fitting part, the plurality of barbs having tip ends being alternately positioned toward each of the opposing main surfaces.

2. The terminal press-fitting structure according to claim 1, wherein each of the barbs further comprises an introduction edge that extends from the respective side edge for introduction into a press-fitted hole of a housing.

3. The terminal press-fitting structure according to claim 2, wherein each of the barbs further comprises a biting part extending from the introduction edge such that the biting part bites into an inner wall of the press-fitted hole.

4. The terminal press-fitting structure according to claim 3, wherein each of the barbs further comprises a locking edge that extends from the biting part.

5. The terminal press-fitting structure according to claim 4, wherein the press-fitted hole comprises locking shoulders located on the inner walls for engaging the locking edges of the barbs.

6. The terminal press-fitting structure according to claim 1, wherein the barbs are swaged.
